(19) United States
(12) Patent Application Publication
(10) Pub. No.: US 2008/0193092 A1
(43) Pub. Date: Aug. 14, 2008

(54) Fiber optic cables having a coupling agent

(76) Inventors: Julian Latelle Greenwood, Hickory, NC (US); Samuel Don Nave, Newton, NC (US); David Alan Seddon, Hickory, NC (US); Kenneth D. Temple, Newton, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/706,099

(22) Filed: Feb. 13, 2007

(51) Int. Cl. G02B 6/44

(52) U.S. Cl. 385/113; 385/114

(57) ABSTRACT

Disclosed are fiber optic cables having a cable jacket or buffer tube with a cavity. Disposed within the cavity are at least one optical fiber and a coupling agent. The coupling agent acts to couple the at least one optical fiber to the cable jacket or buffer tube with a predetermined force, but the coupling agent does not substantially fill a cross-section area of the cavity, thereby providing a nearly “dry” fiber optic cable. Additionally, the fiber optic cable can optionally include one or more water-swellable components for blocking the migration of water within the cavity. Variations include fiber optic cables having the desired flame-retardant ratings for indoor use, outdoor cables with adequate water-blocking, and/or cables suitable for indoor/outdoor use.

### FIELD OF THE INVENTION

The present invention relates generally to fiber optic cables having water-blocking features for use in outdoor and/or indoor environments. Specifically, the fiber optic cables include a coupling agent for providing a predetermined level of coupling.

### BACKGROUND OF THE INVENTION

Fiber optic cables provide high-bandwidth pathways for communication systems and the like. Moreover, the fiber optic cable designs are based upon the intended environment for use. By way of example, fiber optic cables used for outdoor environments typically have a water-blocking mechanism for inhibiting the migration of water along the cable. Whereas, indoor cables typically have flame-retardant characteristics for meeting requirements. Additionally, there are other requirements for fiber optic cable designs depending on the desired environment.

One common construction for water-blocking a fiber optic cable is using a thixotropic grease or gel for completely filling the buffer tubes and/or cables. Thixotropic greases and gels also provided multiple characteristics besides water-blocking along the cable when filling the tube. For instance, the thixotropic greases and gels provide cushioning for the optical fibers, coupling of the optical fibers to the buffer tube, and allow movement of the optical fibers within the buffer tubes. However, thixotropic greases or gels require cleaning from the optical fibers before connectorization, splicing, or the like.

Consequently, other types of materials have been proposed for replacing the thixotropic grease or gel within fiber optic cables. One such material is water-swellable components like water-swellable tapes and/or yarns. However, there are difficulties in replacing the thixotropic grease or gel because it provides other characteristics besides water-blocking. One successful commercial design using water-swellable yarns or threads was the stranded loose tube cable design. In this fiber optic cable design the water-swellable component provided the water-blocking characteristic, but not the coupling. Simply stated, stranding the buffer tubes over a few meters created a suitable level of coupling between the respective optical fibers and the respective tubes. However, replacing the thixotropic grease or gel with other fiber optic cable designs was more difficult.

Illustratively, mono-tube fiber optic cables have been proposed with water-swellable tapes and/or yarns for replacing the thixotropic grease or gel for a “dry” fiber optic cable. However, these fiber optic cable designs can require special installation techniques such as coiling the cable at specified intervals for providing coupling to the optical fibers. Moreover, these fiber optic cable designs may have difficultly providing suitable water-blocking performance. U.S. Pat. No. 5,373,100 discloses a fiber optic cable design for addressing water-blocking concerns by using a water-swellable yarn and completely filling the tube with a thixotropic grease, but the optical fibers still required cleaning. Consequently, other cable designs were developed to address the problem of replacing the thixotropic grease or gels. For example, U.S. Pat. No. 6,970,629 discloses a commercially successful fiber optic cable having a dry insert that replaces the thixotropic grease or gel, while providing similar cable performance characteristics.

Thus, there has been a long-felt need for fiber optic cable designs that provide all of the required performance characteristics along with quick and easy access and deployment without requiring special installation techniques.

### SUMMARY OF THE INVENTION

Disclosed are fiber optic cables having a cable jacket or a tube with a cavity. Disposed within the cavity is at least one optical fiber and a coupling agent. The coupling agent acts to couple the at least one optical fiber to the cable jacket or buffer tube with a predetermined force, but the coupling agent does not substantially fill a cross-sectional area of the cavity. Other optional components for the fiber optic cables include one or more water-swellable components for blocking the migration of water along the cable.

Another aspect of the present invention is directed to a fiber optic cable having at least one optical fiber, at least one strength member, and a cable jacket with a cavity wherein the at least one optical fiber is disposed within the cavity. Also disposed within the cavity is a coupling agent and at least one water-swellable component. The coupling agent provides coupling between the at least one optical fiber and the cable jacket, but the coupling agent does not fill a cross-sectional area of the cavity. Whereas, the at least one water-swellable component is disposed within the cavity for blocking the migration of water within the cavity. Additionally, the optical fiber has a predetermined level of coupling, the predetermined level of coupling being about 0.1625 Newtons or more per optical fiber for a thirty-meter length of fiber optic cable.

Still another aspect of the present invention is a fiber optic cable having at least one optical fiber ribbon, a cable jacket having a cavity wherein the at least one optical fiber ribbon is disposed within the cavity. The cable also includes a first strength member and a second strength member that are disposed on opposite sides of the cavity. Also disposed within the cavity is a coupling agent and at least one water-swellable component. The coupling agent provides coupling between the at least one optical fiber and the cable jacket, but the coupling agent does not fill a cross-sectional area of the cavity. Variations of the invention include fiber optic cables having the desired flame-retardant ratings, outdoor cables with adequate water-blocking and coupling, and/or cable suitable for indoor/outdoor use.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain principals and operations of the invention.

### BRIEF DESCRIPTION OF THE DRAWINGS

FIG. 1 depicts a cross-sectional view of a fiber optic cable according to the present invention.

FIG. 2 depicts a cross-sectional view of another fiber optic cable according to the present invention.

FIG. 3 depicts a cross-sectional view of another fiber optic cable according to the present invention.

FIG. 4 depicts another cross-sectional view of a fiber optic cable according to the present invention.

FIG. 5 depicts still another cross-sectional view of a fiber optic cable according to the present invention.

### DETAILED DESCRIPTION OF THE INVENTION

Reference will now be made in detail to the present preferred embodiments of the invention, examples of which are illustrated in the accompanying drawings. Whenever practical, the same reference numerals will be used throughout the drawings to refer to the same or like parts. FIG. 1 depicts a fiber optic cable 10 according to the present invention. Fiber optic cable 10 includes at least one optical fiber 12, at least one strength member 14, a coupling agent 15, and a cable jacket 18. Cable jacket 18 has a cavity 18a wherein the at least one optical fiber 12 is disposed within cavity 18a along with coupling agent 15. In this cable, optical fiber 12 is a portion of a fiber optic ribbon 12a and other embodiments can have a plurality of ribbons or optical fibers within the cavity. Also disposed within cavity 18a are one or more optional water-swellable components 16 such as a yarn, thread, tape, powder, or the like. Fiber optic cable 10 advantageously provides a scalable fiber optic cable design (i.e., changeable by the fiber count) that allows quick and easy access to the optical fibers within the cavity while being capable of meeting the desired performance characteristics for a variety of environments.

Coupling agent 15 is a suitable material such as a gel, a paste, a wax, a grease, emulsion having the liquid driven off, or the like that does not substantially fill a cross-sectional area of the cavity; but, instead is used for coupling the optical fibers or ribbon to the cable jacket. In other words, the coupling agent provides coupling of the optical fibers to the cavity wall, but cannot block the flow of water along the cavity if it were to enter. Simply stated, the coupling agent does not act as a plug for blocking a portion of the cable cross-section to inhibit the migration of water. Moreover, the coupling agent does not “lock” or connect the optical fiber to the fiber optic cable and prevent movement of a portion of the optical fiber, but instead allows longitudinal movement with a predetermined level of coupling. For instance, not substantially filling a cross-sectional area means the coupling agent fills on average less than 50% of the cavity cross-section and more preferably less than 20% of the cavity cross-section. Water blocking of cavity 18a is provided by an optional water-swellable component 16, which is disposed within cavity 18a. Although, fiber optic cable 10 is not a “dry” fiber optic cable design it only requires removal of a small amount of the coupling agent from the optical fibers before splicing or connectorizing the same, thereby streamlining the process.

As depicted in FIG. 1, fiber optic ribbon 12a has a thin layer (typically between about a few microns thick to a couple hundred microns thick) of coupling agent 15 applied to fiber optic ribbon 12a. In this cable, coupling agent 15 is applied to each major surface (i.e., planar surface) of fiber optic ribbon 12a. Consequently, fiber optic ribbon 12a can advantageously couple to either or both sides of cavity 18a. Moreover, it is relatively easy to apply the coupling agent to the ribbon at fast line speeds. As shown, coupling agent 15 extends over the entire planar portion of the ribbon, but sufficient coupling may be provided by coating less than the entire width of the ribbon. Although, a substantial portion of cavity 18a is not filled, fiber optic cable 10 still provides adequate levels of water-blocking by using one or more water-blocking components 16.

By way of example, typical dimensions for cavity 18a having a single typical twelve-fiber ribbon are about 4 millimeters wide with a height of about 2.0 millimeters and coupling agent 15 has a thickness of about 400 microns (0.4 millimeters) on each side of fiber optic ribbon 12a. Thus, coupling agent 15 does not substantially fill the cavity since it occupies 0.8 millimeters and the height of cavity 18a is 2.0 millimeters, thereby occupying about 40% of the cavity and being unable to block the migration of water. Optionally, one or more water-swellable components 16 such as a plurality of water-swellable yarns are disposed on one or more sides of the fiber optic ribbon 12a and extend along the length of the cavity for blocking the migration of water. Of course, any suitable quantity, size, and/or type of water-swellable components such as one or more yarns, threads, powders, or like may be used for meeting the requirements for water-blocking. For instance, the cable could include a plurality of water-swellable components such as six 450 denier water-swellable yarns within the cavity as shown on both sides of fiber optic ribbon 12a. Likewise, the concepts of the invention are useful with other fiber optic cable with other dimensions and/or designs.

In other variations, the coupling agent can be applied intermittently to the optical fibers, ribbons, cable jacket, buffer tube, and/or cavity for providing a suitable level of coupling along with a water-blocking component. Applying coupling agent intermittently is advantageous because there is less to clean and it also reduces material cost for the cable. For instance, coupling agent is applied in periodic intervals along the cable for providing coupling. Likewise, the water-blocking component such as a water-swellable powder could also be applied intermittently. Furthermore, the coupling agent and water-swellable component could alternate along the length of the fiber optic cable.

Fiber optic cable 10 also includes a sheath system having at least one strength member 14 and cable jacket 18. Fiber optic cable 10 is a tubeless configuration meaning that once cable jacket 18 is breached access to the optical fibers or ribbons is possible without further entry into a buffer tube or the like. Moreover, optical fiber ribbon 12a is not stranded (i.e., not twisted) within cavity 18a as typically done within round cables since it has a generally rectangular shape. Consequently, there is a relatively large surface area for the coupling agent to contact because the surfaces are generally aligned. In short, the major surfaces of the ribbon (i.e. top and bottom planar surfaces) are generally aligned with the top and bottom of the cavity along the length of the cable.

As depicted, fiber optic cable 10 also includes two strength members 14 with each strength member being attached to cable jacket 18 and disposed on opposite sides of cavity 18a, thereby forming a non-round cable having a relatively flat cable cross-section and a generally rectangular cavity. As shown, cavity 18a has a height that is larger than a diameter of strength member 14 so that it is possible to enter cavity 18a without damaging strength members 14. By way of example, cavity 18a has a height of about 2.0 millimeters and strength members 14 are glass reinforced plastic (GRPs) having a diameter of about 1.6 millimeters. Any suitable materials are possible for strength members 14 such as glass-reinforced plastics (GRPs), aramid reinforced plastics (ARPs), metallic wires, fiberglass, or the like. Likewise, cable jacket 18 is constructed of any suitable material for the intended environment such as polyethylene, PVC, polypropylene, or the like. Additionally, the strength members can include a coating for promoting bonding with the cable jacket. For instance, suitable coatings include a thermoplastic material, ethylene-acrylic acid (EAA), ethylene-vinyl acetate (EVA), rubber, or the like.

Coupling agent 15 provides a predetermined level of coupling for the optical fibers so they are not easily displaced from their intended position. In order to quantify the amount of coupling for the optical waveguides a relatively long length of fiber optic cable is required. By way of example, optical fibers of cables according to the present invention have a coupling force of at least about 0.1625 Newtons per optical fiber for a thirty-meter length of fiber optic cable. Illustratively, a fiber optic cable having a single ribbon with twelve optical fibers in the ribbon should have a coupling force of about 1.95 Newtons or greater for a thirty-meter length of fiber optic cable. Likewise, a similar fiber optical cable having a single optical fiber ribbon with four optical fibers should have a coupling force of about 0.650 Newtons or greater for a thirty-meter length of fiber optic cable. Measurement of the coupling force is accomplished by taking a thirty-meter fiber optic cable sample and pulling on a first end of the optical fibers (or fiber optic ribbon(s)) and measuring the force required to cause movement of the second end of the optical fiber(s) (or fiber optic ribbon(s)). In other words, the excess fiber length (EFL) (or ERL) must be straightened so that the coupling force is the amount of force required to move the entire length of optical fibers within the thirty-meter fiber optic cable sample.

Fiber optic cables according to the present invention can also have flame-retardant ratings such as plenum, riser, indoor/outdoor, or other ratings. Because fiber optic cables of the present invention significantly reduce the amount of the conventional thixotropic grease or gel that typically fills a cable cavity, they also reduce the amount of fuel load within the cable, thereby making meeting flame-retardant ratings easier to achieve than with conventional fiber optic cables. However, the fiber optic cables still include other components/materials therein that make it difficult to meet flame-retardant ratings such as the optical fibers or ribbons. In other embodiments of the present invention, coupling agent 15 includes a flame-retardant material for meeting the desired cable rating such as riser, plenum, low-smoke zero-halogen, etc. By way of example, the coupling agent could include flame-inhibiting materials or agents such as antimony trioxide, aluminum trihydrate, zinc borate, magnesium hydroxide, or other known materials for meeting the desired rating. Moreover, cable jacket 18 (and/or buffer tube) can also use a material that provides a flame-retardant rating such as polyvinyl chloride (PVC), flame-retardant polyethylene (FRPE), flame-retardant polypropylene (FRPP) or the like, thereby achieving the desired rating. Moreover, coupling agents may be non-petroleum-based.

Illustratively, fiber optic cables for riser-ratings use a PVC jacket along with a non-petroleum based coupling agent such as silicone-based or ester-based gels or pastes since the petroleum-based coupling agents leaches plasticizers from the PVC that causes brittleness and/or cracking of the material. Examples of suitable materials include PVCs having an limiting oxygen index (LOI) of about 28% or greater such as available from AlphaGary of Leominster, Mass. under the tradenames GW 2337-A or GW 2271 and which provide suitable low-temperature handling. Likewise, examples of suitable FRPEs have an LOI of about 35% or greater such as also available from AlphaGary under the tradename Sentra 8142. For plenum-rated fiber optic cables, the jacket is a PVDF or other suitable materials such as fluoropolymers like FEP, MFA, other fluoropolymer-based compound, or even PVCs.

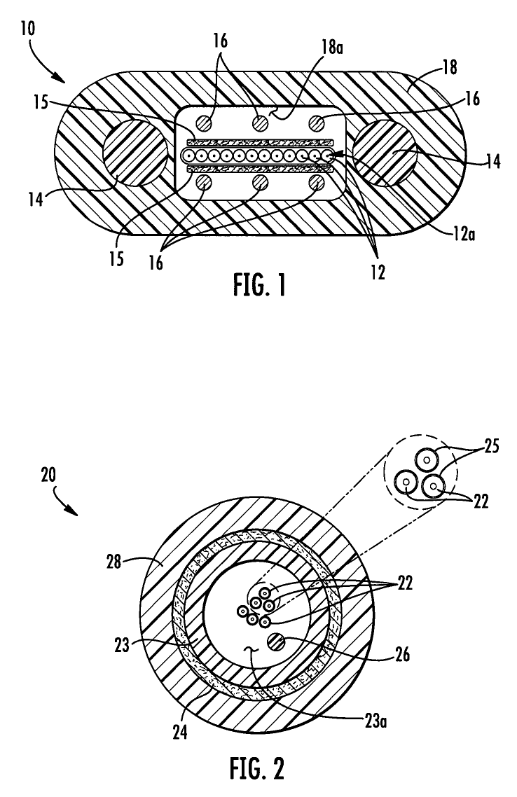

The concepts of the present invention are suitable with other fiber optic cable designs. FIG. 2 depicts a cross-sectional view of a fiber optic cable 20 having a tube assembly according to the present invention. Specifically, fiber optic cable 20 includes a plurality of loose optical fibers 22 having a coupling agent 25 thereon, which are disposed within a tube 23 along with a water-blocking component 26. As before, coupling agent 25 provides the adequate level of coupling for the optical fibers, but does not substantially fill a cross-sectional cavity 23a of tube 23. In this embodiment, a water-swellable yarn is used as the water-blocking component 26. Fiber optic cable 20 also includes a layer of strength components 24 such as aramid, fiberglass, or the like surrounded by a cable jacket 28. Strength components 24 may also include a water-swellable characteristic for blocking the migration of water outside of tube 23. Further, other cable components may be disposed between tube 23 and cable jacket 28 such as one or more flame-retardant tapes that char or resist burning. Likewise, other cable components include a water-swellable tape, armor, ripcord, and/or the like.

FIG. 3 depicts a cross-sectional view of another fiber optic cable 30 according to the present invention. Fiber optic cable 30 is similar to fiber optic cable 10, but it includes a plurality of ribbons 12a and jacket 38 includes a tonable lobe 38b for locating the cable. Specifically, coupling agent 15 is located on both sides of two ribbons 12a as shown and also creates a relatively high surface tension between the ribbons. Fiber optic cable 30 also includes a water-swellable component on both sides of the ribbons within a cavity 38a. Toning lobe 38b is helpful for locating the fiber optic cable when buried since it allows the transmission of a signal on its conductive wire. Consequently, toning lobe 38b includes a toning wire 39 and has a preferential tear portion for separating the toning lobe 38b from the main cable body. By way of example, toning wire 39 is 24-gauge copper wire, but other suitable conducting wires are possible.

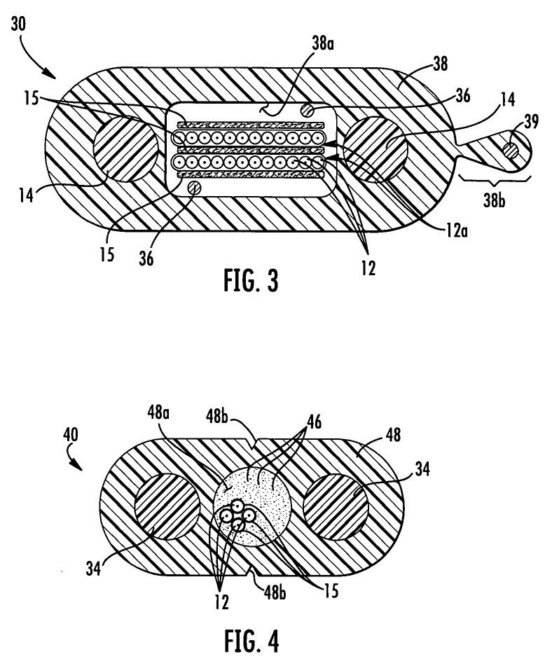

FIG. 4 depicts a cross-sectional view of another fiber optic cable 40. Fiber optic cable 40 includes a tubeless flat cable design with a jacket 48 having a generally round cavity 48a. Within cavity 48a is a water-swellable powder 46 and a bundle of optical fibers 12 having a coupling agent 15 thereon. Like the other cable designs, coupling agent 15 does not substantially fill the cross-sectional area of the cavity, but provides coupling and water-swellable powder 48 inhibits the migration of water along the fiber optic cable. Strength members 34 are formed from a glass-reinforced plastic (GRP) material. Jacket 48 also includes a pair of notches 48b generally aligned over cavity 48a, thereby making it easier to break open and access the optical fibers therein.

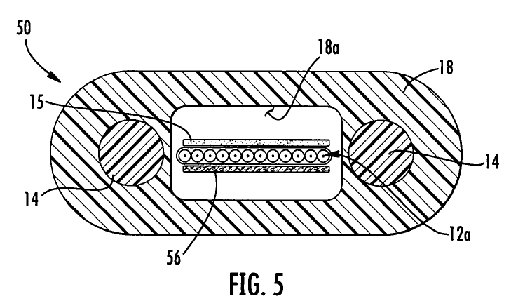

FIG. 5 depicts a cross-sectional view of another fiber optic cable 50. Fiber optic cable 50 is similar to fiber optic cable 10, expect a coupling agent 15 is only disposed on one side of a ribbon 12a to provide a suitable level of coupling. Additionally, the water-blocking component of fiber optic cable 50 is a water-swellable tape 56 that is disposed on the other side of ribbon 12a. Otherwise, fiber optic cable 50 includes cable jacket 18 having strength members 14 attached thereto and which forms cavity 18a. Other variations of the fiber optic cable using a generally rectangular tube within cable jacket 18 to form the cavity that houses the optical fiber and water-swellable component so that the optical fiber is coupled to the rectangular tube by the coupling agent. In other words, the rectangular tube provides the cavity for the fiber optic cable.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A tubeless fiber optic cable comprising:
at least one optical fiber;
at least two strength members;
a cable jacket, the cable jacket having a cavity wherein the at least one optical fiber is disposed within the cavity and the at least two strength members are disposed on opposite sides of the cavity and attached to the cable jacket; and
a coupling agent, the coupling agent disposed within the cavity for coupling the at least one optical fiber to the fiber optic cable, but the coupling agent does not substantially fill a cross-sectional area of the cavity.

2. The fiber optic cable of claim 1, further including at least one water-swellable component, the at least one water-swellable component being disposed within the cavity for blocking the migration of water within the cavity.

3. The fiber optic cable of claim 1, the at least one optical fiber having a predetermined level of coupling to the fiber optic cable, the predetermined level of coupling being about 0.1625 Newtons or more per optical fiber for a thirty meter length of fiber optic cable.

4. The fiber optic cable of claim 1, wherein the coupling agent is flame-retardant.

5. The fiber optic cable of claim 1, wherein the at least one optical fiber is a portion of a fiber optic ribbon.

6. (canceled)

7. The fiber optic cable of claim 1, further including at least one water-swellable component, the at least one water-swellable component being a water-swellable yarn, a water-swellable tape, or a water-swellable powder.

8. The fiber optic cable of claim 1, the coupling agent having a non-petroleum base.

9. The fiber optic cable of claim 1, wherein the fiber optic cable is flame-retardant.

10. A fiber optic cable comprising:
at least one optical fiber;
at least one strength member;
a cable jacket, the cable jacket having a cavity wherein the at least one optical fiber is disposed within the cavity;
a coupling agent, the coupling agent disposed within the cavity for coupling the at least one optical fiber to the cable jacket, but the coupling agent does not substantially fill a cross-sectional area of the cavity, wherein the at least one optical fiber has a predetermined level of coupling, the predetermined level of coupling being about 0.1625 Newtons or more per optical fiber for a thirty meter length of fiber optic cable; and
at least one water-swellable component, the at least one water-swellable component being disposed within the cavity for blocking the migration of water within the cavity.

11. The fiber optic cable of claim 10, wherein the coupling agent is flame-retardant.

12. The fiber optic cable of claim 10, wherein the at least one optical fiber is a portion of a fiber optic ribbon.

13. The fiber optic cable of claim 10, further including two strength members, the two strength members being disposed on opposite sides of the cavity.

14. The fiber optic cable of claim 10, the at least one water-swellable component being a water-swellable yarn, a water-swellable tape, or a water-swellable powder.

15. The fiber optic cable of claim 10, the coupling agent having a non-petroleum base.

16. The fiber optic cable of claim 10, wherein the fiber optic cable is flame-retardant.

17. A fiber optic cable comprising:
at least one optical fiber ribbon, wherein the at least one optical fiber ribbon has a predetermined level of coupling, the predetermined level of coupling being about 0.1625 Newtons or more per optical fiber of the at least one optical fiber ribbon for a thirty meter length of fiber optic cable;
a cable jacket, the cable jacket having a cavity wherein the at least one optical fiber ribbon is disposed within the cavity;
a first strength member;
a second strength member, wherein the second strength member and the first strength member are disposed on opposite sides of the cavity;
a coupling agent, the coupling agent disposed within the cavity for coupling the at least one optical fiber ribbon to the cable jacket, but the coupling agent material does not substantially fill a cross-sectional area of the cavity; and
a first water-swellable component, the first water-swellable component being disposed within the cavity for blocking the migration of water within the cavity.

18. The fiber optic cable of claim 17, wherein the coupling agent is flame-retardant.

19. (canceled)

20. The fiber optic cable of claim 17, the at least one water-swellable component being a water-swellable yarn, a water-swellable tape, or a water-swellable powder.

21. The fiber optic cable of claim 17, the coupling agent having a non-petroleum base.

22. The fiber optic cable of claim 17, wherein the fiber optic cable is flame-retardant.
